(19) United States
(12) Patent Application Publication
(10) Pub. No.: US 2011/0220677 A1
(43) Pub. Date: Sep. 15, 2011

(54) METHOD AND SYSTEM FOR CONTROLLING THE UNLOADING OF GRAINS OR SIMILAR MATERIALS FROM A CART

(75) Inventor: Nicola Bertolani, Carbonara di Po (IT)

(73) Assignee: DINAMICA GENERALE S.R.L., Poggio Rusco (IT)

(21) Appl. No.: 13/023,644

(22) Filed: Feb. 9, 2011

Related U.S. Application Data
(60) Provisional application No. 61/379,541, filed on Sep. 2, 2010.

(30) Foreign Application Priority Data
Feb. 9, 2010 (IT) BO2010A000070

(51) Int. Cl. B67D 7/08

(52) U.S. Cl. 222/1; 222/58

(57) ABSTRACT

A system for controlling the unloading of grains from a cart, which has a grain container and an unloading duct for unloading the grains, having an inlet communicating with the container and an adjusting device for closing or opening the inlet. The control system has load cells for detecting the weight of the container, an electric actuator for driving the adjusting device, a keyboard for acquiring a target weight of grains to be unloaded, and an electronic control unit configured to determine a weight threshold as a function of the target weight, to real-time determine, while unloading, the weight of the grains unloaded as a function of the weight detected by the load cells, and to control the actuator so that the adjusting device closes the inlet as soon as the weight of the grains unloaded reaches the weight threshold.

### CROSS REFERENCE TO RELATED APPLICATIONS

This application claims the benefit of U.S. Provisional Application Ser. No. 61/379,541, filed on Sep. 2, 2010; and claims priority to Italian Application No. BO2010A000070, Filed Feb. 9, 2010, the entire contents of all of which are incorporated by reference as if fully set forth.

### FIELD OF INVENTION

The present invention relates to a method for controlling the unloading of grains or similar materials from a cart, and to a corresponding control system which implements such a method.

### BACKGROUND

In particular, the present invention is advantageously, but not exclusively, applied in grain carts towed by tractors and used to collect a load of grains from an harvesting machine, such as a combine harvester for example, transport it away from the combine harvester and unload it into another container away from the field where the grains were harvested, to which the following description will explicitly refer without therefore loosing in generality.

A grain cart comprises a high-capacity, hopper-shaped container, normally called a storage hopper, for storing grains received from a harvesting machine, for example a combine harvester, and an unloading duct for unloading the grains from the hopper to another container, e.g. to another cart towed by a tractor, in a trailer towed by a truck, in a silo, or in a granary. The unloading duct is normally provided with conveying means for conveying the grains towards the outlet of the unloading duct which is to be usually positioned at a higher level than the inlet of the unloading duct. Said conveying means comprise, for example, an auger arranged inside the duct and driven by the Power Take-Off (PTO) of the tractor. The unloading duct is provided with an adjusting device consisting, for example, of a movable partition arranged at the inlet of the unloading duct and manually operable by an operator to adjust the grain flow through the inlet.

To start an unloading operation, the operator drives the adjusting device so as to open the inlet of the unloading duct. The grains enter the unloading duct, where the auger, while turning, conveys them towards the outlet. The operator visually controls the unloading operation and when he/she sees that the external container is full, he/she operates the control device so as to close the inlet and terminate the unloading operation. Such an operation mode hardly ever allows the external container to be optimally filled, because the optimal success of the unloading operation depends on the operator's diligence and ability.

Grain carts are known, which are provided with a control system comprising weight detecting devices consisting, for example, of load cells to weigh the storage hopper and an electronic control unit, which is connected to the load cells to acquire weight data from the storage hopper and is configured to determine, during the unloading operation, the weight of the grains unloaded as a function of the acquired weight data and display in real time the weight thus determined. This control system helps the operator in monitoring the unloading but is not sufficient to always ensure the optimal filling of the external container.

### SUMMARY

The object of the present invention is to provide a method for controlling the unloading of grains from a cart and to provide a corresponding control system, which are free from the above-described drawbacks, while being easy and cost-effective to be implemented.

In accordance with the present invention, a control method and system is provided for controlling the unloading of grains or similar materials from a cart, as defined in the appended claims.

### BRIEF DESCRIPTION OF THE DRAWINGS

The present invention will now be described with reference to the accompanying drawings, which illustrate a non-restrictive embodiment thereof, in which:

FIG. 1 shows a grain cart provided with the control system to control the unloading of grains provided according to the dictates of the present invention;

FIG. 2 shows a detail of the cart in FIG. 1; and

FIG. 3 shows a time diagram of the weight of the grains unloaded from the cart in FIG. 1.

### DETAILED DESCRIPTION OF THE PREFERRED EMBODIMENTS

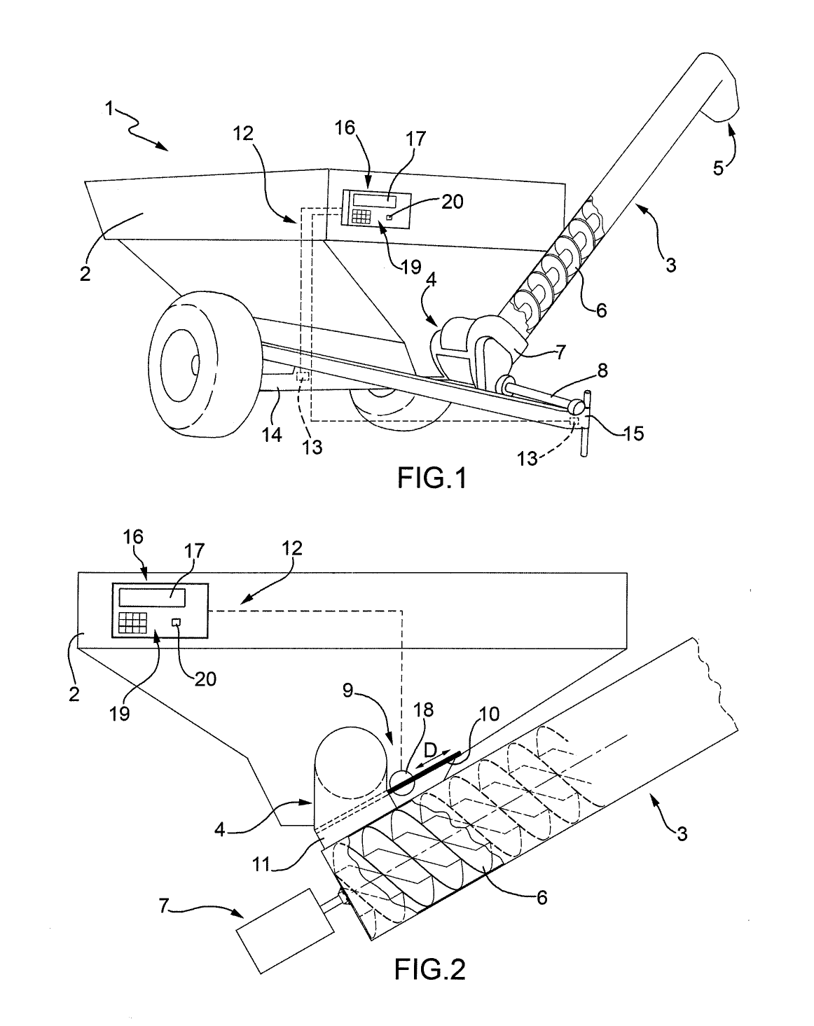

In FIG. 1, reference numeral 1 generally indicates, as a whole, a grain cart of the single-axle type. Cart 1 comprises a hopper-shaped container 2 to store grains, e.g. a load of grains received from a combine harvester (not shown), and an unloading duct 3 for unloading the grains out of container 3, e.g. into another container (not shown), i.e. an external container such as the body of another cart towed by a tractor, the body of a trailer towed by a truck, or a granary silo. The unloading duct 3 comprises an inlet 4 communicating with the bottom of container 3 to receive the grains and is provided with conveying means to convey the grains along the unloading duct 3 towards its outlet 5, which is usually positioned, in use, at a higher level than inlet 4. The conveying means comprises, for example, an auger 6 arranged inside at least one part of the unloading duct 3 and an auger moving assembly 7, which draws motive power from a tractor PTO (not shown) by means of a transmission shaft 8.

With reference to FIG. 2, diagrammatically showing a part of the unloading duct 3 close to the inlet 4 and the auger moving assembly 7 without its external carter, cart 1 comprises an adjusting device 9 arranged at the inlet 4 to adjust the grain flow through inlet 4. In the exemplary embodiment of FIG. 2, the adjusting device 9 comprises a movable partition 10 along a direction D transversal to a portion 11 of the unloading duct 3 close to inlet 4 so as to enter and exit from the unloading duct 3 through a slot (not shown) in the wall of portion 11. In particular, partition 10 is movable between a closing position of inlet 4, in which partition 10 (shown with a dotted line in FIG. 2) is inserted into the unloading duct 3 so as to prevent the grains from passing, and an opening position of inlet 4, in which partition 10 (shown with a thick black line in FIG. 2) is extracted from the unloading duct 3 so as to permit the grains to pass.

Cart 1 is equipped with a control system 12 to control the unloading of the grains from cart 1, which control system 12 is provided according to the invention. The control system 12 particularly implements the method for controlling the unloading of the grains according to the invention, as described below.

With reference again to FIG. 1, control system 12 comprises one or more weight detecting devices associated with container 2, so as to detect the weight of container 2. Each weight detecting device consists, for example, of a respective load cell 13. At least one cell 13 is arranged beneath container 2 at axle 14 of cart 1, and another load cell 13 is arranged at shaft 15 of cart 1. Control system 12 comprises an electronic control unit 16 connected to the load cells 13 to acquire weight data of container 2 and configured to determine in real-time, during an unloading operation, i.e. while the unloading operation is underway, the weight of the grains unloaded as a function of the acquired weight data. The control unit 16 further comprises a display 17 for displaying the weight of the grains unloaded.

With reference to FIG. 2, control system 12 comprises, in accordance with the invention, an actuator 18 which is controllable by the control unit 16 to drive the adjusting device 9 so as to close or open inlet 4, and a keyboard 19 to allow an operator to set up several parameters of control unit 16 and provide commands to the control system 12. Actuator 18 comprises an electric motor and a rack-and-pinion assembly, which is known per se and therefore not shown, to cinematically couple the motor to partition 10. Until cart 1 needs to be unloaded, actuator 18 keeps the adjusting device 9 in the closing position of inlet 4.

Control unit 16 is configured to perform a series of steps, in accordance with the control method of the present invention.

Before starting an unloading operation, control unit 16 acquires a target weight PTOT corresponding to the total amount of grains to be unloaded in the unloading operation. For example, the target weight corresponds to the capacity of the external container to be filled, that is, to the total quantity of grains which may be contained in the external container. The target weight PTOT is acquired by means of keyboard 19, i.e. it may be set directly by the operator. Control unit 16 determines a weight threshold PTH as a function of the target weight PTOT.

Control unit 16 advantageously determines the weight threshold PTH upon acquisition, again by means of keyboard 19, of a further parameter consisting of a weight deviation ΔP corresponding to the capacity of the unloading duct 3, that is, to the quantity of grains which may be contained within the unloading duct 3 between inlet 4 and outlet 5. Therefore, the weight threshold PTH is calculated as the difference between the target weight PTOT and the weight deviation ΔP.

At this point, the control unit 16 awaits an unloading start command, which should be given by the operator and which is acquired by control unit 16 by means of keyboard 19. In the meantime, the auger moving assembly 7 is activated independently. Keyboard 19 advantageously comprises a dedicated key 20 (FIGS. 1 and 2) for acquiring the unloading start command. As soon as the operator presses key 20, the control unit 16 commands actuator 18 to move the adjusting device 9 into the opening position of inlet 4. Thus, the grains are poured into the unloading duct 3 through inlet 4 and are conveyed towards outlet 5 by auger 6. Therefore, pressing key 20 starts the unloading operation.

During the unloading operation, the control unit 16 acquires weight data from container 2 by means of the load cells 13, determines in real-time the weight of the grains unloaded as a function of the weight data acquired, and compares the weight of the grains unloaded to the weight threshold PTH. In particular, control unit 16 is configured to measure, by means of the load cells 13, the weight variation of container 2 from the beginning of the unloading operation and to determine in real-time the grain weight as a function of the measured weight variation. During the unloading operation, the weight of container 2 decreases with a speed proportional to the rotation speed of auger 6 and therefore the weight variation of container 2 while unloading is always a negative value. The weight of the grains unloaded is determined as the absolute value of the weight variation of container 2 and therefore is a weight value which grows with a speed proportional to the rotation speed of auger 6.

As soon as the weight of the grains unloaded reaches the weight threshold PTH, control unit 16 commands the actuator 18 to move the adjusting device into the closing position of inlet 4. At this instant, the weight of the grains unloaded is equal to the difference PTOT-ΔP. The auger moving assembly 7 is left on, so that the auger 6, while turning, unloads the quantity of grains still inside the unloading duct 3 between inlet 4 and outlet 5. Therefore, when the unloading duct 3 has completely emptied, the overall weight of the grains unloaded is equal to the target weight PTOT.

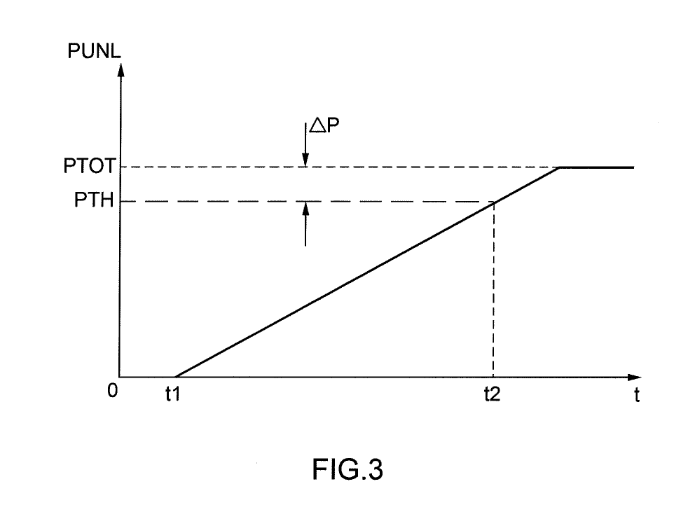

FIG. 3 shows, merely by way of example, a simplified time diagram of the weight of the grains unloaded, indicated by PUNL. T1 indicates the time instant in which the operator presses key 20, and therefore the instant when inlet 4 of the unloading duct 3 is opened, and t2 indicates the time instant when the PUNL reaches the weight threshold PTH, thus causing inlet 4 to close.

According to further embodiments of the invention not shown herein, the weight detecting devices comprise, instead of the load cells 13, a plurality of variable resistance devices, or a plurality of hydraulic measurement devices, or another type of weight detecting devices adapted to be assembled between container 2 and axle 14 of cart 1 and on shaft 15 of cart 1.

From the above description, it becomes apparent that the control system 12 operates just as effectively for any other type of adjusting device 9, provided that it comprises an actuator 18 adapted to drive that particular type of adjusting device 9. For example, the adjusting device 9 may be a valve arranged inside the unloading duct 3, consisting of a circular partition rotating about an axis perpendicular to the longitudinal axis of portion 11 of the unloading duct 3. In this case, actuator 18 comprises an electric motor coaxially coupled with the rotation axis of the valve.

Moreover, the control system 12 may also be applied without modifications to a cart 1 unloadable by gravity, i.e. of the type comprising an unloading duct without grain conveying means, the outlet being usually positioned in use at a lower level than the inlet.

The main advantage of the above-described system and method for controlling the unloading of grains from a cart as compared to known unloading control systems is that of allowing an external container to be optimally, automatically filled. Optimal filling is ensured by controlling the closing of the unloading duct 3, carried out as a function of two parameters, such as the target weight PTOT and the duct capacity ΔP, configurable by the operator. Automatism is obtained due to the opening and closing of the unloading duct 3 being controlled for an unloading operation by means of the single press of a button 20.

What is claimed is:

1. Method for controlling the unloading of grains from a cart (1), which comprises a grain container (2), an unloading duct (3) for unloading the grains from the container (2), the unloading duct (3) comprising an inlet (4) communicating with the container (2) to receive the grains, and an adjusting device (9) to adjust the grain flow through said inlet (4); the method comprising:
real-time determining, during unloading and by at least one weight detecting device (13) associated to said container (2), the weight of the grains unloaded;
acquiring a target weight (PTOT) corresponding to a total quantity of grains to be unloaded during an unloading operation;
determining a weight threshold (PTH) as a function of the target weight (PTOT);
comparing, during unloading, the weight of the grains unloaded with the weight threshold (PTH); and
actuating the adjusting device (9), as soon as the weight of the grains unloaded reaches the weight threshold (PTH), in order to close said inlet (4).

2. Method according to claim 1, wherein determining a weight threshold (PTH) as a function of the target weight (PTOT) comprises:
acquiring a weight deviation (ΔP) corresponding to the grain quantity which can be contained inside said unloading duct (3); and
calculating the weight threshold (PTH) as a function of the target weight (PTOT) and the weight deviation (ΔP).

3. Method according to claim 1, further comprising:
acquiring an unloading start command; and
actuating the adjusting device (9) as soon as the unloading start command is acquired, in order to open said inlet (4) so that said unloading operation can be started.

4. Method according to claim 1, wherein real-time determining, during unloading and by at least one weight detecting device (13) associated with said container (2), the weight of the grains unloaded comprises;
real-time measuring, by said weight detecting device (13), the weight variation of the container (2) since the beginning of the unloading operation; and
real-time determining the weight of the grains unloaded as a function of the weight variation measured.

5. Control system for controlling the unloading of grains from a cart (1), which comprises a grain container (2), an unloading duct (3) for unloading the grains from the container (2), the unloading duct (3) comprising an inlet (4) communicating with the container (2) to receive the grains, and an adjusting device (9) to adjust the grain flow through said inlet (4); the control system (12) comprising at least one weight detecting device (13) for detecting the weight of the container (2) and an electronic control unit (16) connected to the weight detecting device (13) to acquire weight data of the container (2) and configured to real-time determine the weight of the grains unloaded as a function of the weight data acquired; the control system (12) comprising an actuator (18) for driving said adjusting device (9) and human-machine interface (17, 19) for acquiring a target weight (PTOT) corresponding to the total quantity of grains to be unloaded during an unloading operation, said control unit (16) is configured to determine a weight threshold (PTH) as a function of the target weight (PTOT), to compare, during unloading, the weight of the grains unloaded with the weight threshold (PTH) and, as soon as the weight of the grains unloaded reaches the weight threshold (PTH), to control the actuator (18) so that the adjusting device (9) closes said inlet (4).

6. Control system according to claim 5, wherein said human-machine interface (17, 19) is configured to acquire a weight deviation (ΔP) corresponding to the grain quantity which can be contained inside the unloading duct (3); said control unit (16) being configured to calculate said weight threshold (PTH) as the difference between said target weight (PTOT) and said weight deviation (ΔP).

7. Control system according to claim 5, wherein said human-machine interface (17, 19) is adapted to acquire an unloading start command; said control unit (16) being configured to control said actuator (18) so that said adjusting device (9) opens said inlet (4) as soon as the unloading start command is acquired.

8. Control system according to claim 5, wherein said control unit (16) is configured to measure, by said weight detecting device (13), the weight variation of the container (2) since the beginning of the unloading operation and to real-time determine the weight of the grains as a function of a weight variation detected.

9. Cart for grains comprising a grain container (2), an unloading duct (3) for unloading the grains from the container (2), which unloading duct (3) comprises an inlet (4) communicating with the container (2) to receive the grains and an adjusting device (9) to adjust the grain flow through said inlet (4), and a control system (12) for controlling the unloading of the grains; wherein the control system (12) is of the type claimed in claim 5.
